(19) United States
(12) Patent Application Publication
(10) Pub. No.: US 2006/0174740 A1
(43) Pub. Date: Aug. 10, 2006

(54) Perforating device

(75) Inventor: Reinhold Linke, Wuppertal, DE (US)

Correspondence Address: Friedrich Kueffner, Suite 910, 317 Madison Avenue, New York, NY, 10017, US

(73) Assignee: Korbach Werkzeug Co. GmbH & Co., KG

(21) Appl. No.: 11/347,032

(22) Filed: Feb. 3, 2006

(30) Foreign Application Priority Data
Feb. 5, 2005 (DE) 10 2005 005 381.5

(51) Int. Cl. B26F 1/24

(52) U.S. Cl. 83/660

(57) ABSTRACT

A device for processing wallpaper bonded to a surface, includes a rotatable, motor-driven carrier, on which the processing tools are provided; with a holder for the rotatable carrier, where the free ends of the processing tools act on certain areas of the wallpaper to be processed, and where the processing tools and the carrier are surrounded by a protective part. The processing tool is a perforating tool. After the perforating tool has been set against the wallpaper, the distance between the protective part and the wallpaper to be perforated can be adjusted. For this purpose, the holder of the carrier is constructed in the form of an adjusting sleeve with a clamping ring and by mounting the holder on the protective part, wherein the clamping ring mounted on the protective part surrounds the adjusting sleeve.

### BACKGROUND OF THE INVENTION

1. Field of the Invention

The present invention relates to a device for processing wallpaper bonded to a surface, with a rotatable, motor-driven carrier, on which the processing tools are provided; with a holder for the rotatable carrier, where the free ends of the processing tools act on certain areas of the wallpaper to be processed, and where the processing tools and the carrier are surrounded by a protective part.

2. Description of the Related Art

These types of devices have become known through DE 9 012 203.8 U1. The processing tool has the effect of roughening or abrading the surface to be processed. As a result of this roughening and abrading, however, the wallpaper is not removed with sufficient gentleness. Devices for perforating wallpaper are described in the publication AT-PS 372 340. As a result, the wallpaper is made permeable, so that a solvent can be used to dissolve the adhesive on the rear surface of the wallpaper. This is especially important in the case of synthetic wallpaper or fiberglass wallpaper, because the wallpaper itself is water-tight. Manual rollers which carry perforating tools in the form of needles are known. By rolling these needles back and forth over the wallpaper several times, the paper is perforated. Manual perforation of this type is relatively laborious and takes a relatively long time. In addition, it cannot be guaranteed that the perforating tools are pressed uniformly into the wallpaper. The wallpaper is sometimes partially torn instead, which makes it relatively difficult to remove the wallpaper web itself.

### SUMMARY OF THE INVENTION

It is the object of the invention to provide a device of the type indicated above which is constructed in such a way that the perforation proceeds easily and uniformly. It should also be possible for the user to carry out the perforation work in a simple manner. Finally, the user should also be protected against any injury by the perforating tool.

In accordance with the invention the object is met in that the processing tool is a perforating tool, and in that, after the perforating tool has been set against the wallpaper, the distance between the protective part and the wallpaper to be perforated can be adjusted, this being accomplished by constructing the holder of the carrier in the form of an adjusting sleeve with a clamping ring and by mounting the holder on the protective part, where the clamping ring mounted on the protective part surrounds the adjusting sleeve. The part which protects the perforating tool allows the safe handling of the device. The ability to adjust the height of the protective part above the wallpaper means that the perforating tool can penetrate to an adjustable depth into the wallpaper, which is important if, for example, the wallpaper is covered by several layers of paint. Being able to change the distance also guarantees that the substrate to which the wallpaper is glued is not damaged by the perforating tool. Finally, the electric motor which drives the device makes the work much easier for the user. The wallpaper to be perforated can be treated more quickly, so that the time it takes to remove the wallpaper is reduced. It is advisable to design the protective part in the form of a hood, which covers the carrier, the perforating tools, and the section of wallpaper to be processed to ensure that no pieces of wallpaper can be thrown by the perforating tool toward the user and that no injury can occur through the use of the perforating tool, because the protective hood forms the component by which the device is brought into contact. Finally, it is also guaranteed that the perforating tools cannot be pushed against any edges or the like and thus cannot cause any damage.

It is advantageous to design the holder of the carrier in the form of an adjusting sleeve and to mount it on the protective part. The clamping ring mounted on the protective part surrounds the adjusting sleeve. By means of a holder of this type it is possible to use the adjusting sleeve to adjust the height of the protective part with respect to the perforating tools. The clamping ring itself provides a secure hold. It is advisable here for the clamping ring to have an internal thread and for the adjusting sleeve to have an external thread, where the adjusting sleeve is supported rotatably in the clamping ring. By the rotation of the adjusting sleeve in conjunction with the internal and external threads, it is therefore possible to lower the protective part relative to the perforating tools or to raise it from the wallpaper, whereas the position of the carrier itself remains unchanged. It is especially worth recommending that the screw connection used to hold the clamping ring on the protective part extend around only a small angle of the clamping ring, so that, upon actuation of the clamping ring screw, the diameter of the clamping ring can be reduced or increased. When the clamping ring screw is loosened, it is possible to turn the adjusting sleeve with ease and sensitivity.

It is advantageous for perforating tools to be distributed uniformly around the rotational circumference of the carrier, so that, during the perforating operation, uniform pressure can be applied and uniform penetration can be achieved. It is recommended that the perforating tool be designed as a circular blade, preferably as a set of two circular blades. The knife blade itself carries individual tooth-like spikes, which perforate the wallpaper. The tools are driven via the carrier, where the circular blades roll along the wallpaper, so that the spikes on the knife blades penetrate into the wallpaper one after the other.

In a special exemplary embodiment of the invention, the carrier is constructed out of a rotating ring and a pintle. The rotating ring is mounted nonrotatably on the pintle. The pintle provides secure support for the rotating ring, whereas the ring itself can hold the perforating tools, so that they are driven uniformly.

It is advantageous for the perforating tools which are mounted on the carrier and which can rotate around axles to be designed as rollers with spikes, so that, as a result of the applied pressure and the rotational movement, the spikes on the rollers can be pushed one after the other into the wallpaper and the surface of the wallpaper can be perforated uniformly. To achieve the easiest possible operation, the end of the pintle facing away from the rotating ring is provided with a flexible shaft, which can be driven by an electric motor. The flexible shaft increases the handiness of the device. The device can be pressed onto the wallpaper to be perforated, whereas the electric motor takes care of the rotational movement. The user can carry the electric motor, in which case the electric motor would be battery-operated. To simplify the operation and handiness of the unit, the end of the pintle carrying the flexible shaft is mounted in a handle. The drive unit therefore does not get in the way of the user. To determine how far the perforating spikes of the tool project, an indicator can be provided to display the rotational angle of the adjusting sleeve with respect to the clamping ring. The rotational angle itself is then a measure of the depth of penetration of the perforating tool into the wallpaper.

To ensure that the device does not become clogged by pieces of wallpaper during the perforating work, the hood-like protective part carries ejection openings, which extend outward from the hood, around its circumference. When the carrier turns and thus the perforating tools move, the wallpaper or paint residues are spun outward and escape from the hood-like protective part.

So that the perforating parts can be easily replaced, it is recommended that the protective part be provided on its circumference with an access opening. Through this opening, a tool can be introduced to the screw which holds the perforating tool on the carrier, so that the screw can be loosened and the tool can be replaced. So that the individual rotatable perforating tools can be easily attached to the circumference of the rotating ring, this ring has threaded openings for the mounting of the axles on which perforating tools are mounted. The axles of the perforating tools can be screwed into these threaded openings. It is advisable for the threaded openings to extend radially with respect to the axis of rotation of the rotating ring, so that the perforating tool will rotate uniformly. In the case of another exemplary embodiment, the threaded openings are tangential to the axis of rotation. During the rotation of the rotating ring, the sharply pointed perforating tools will thus perform a slightly sliding movement, which has the effect of tearing the wallpaper slightly.

In a special exemplary embodiment of the invention, the rotating ring and/or the pintle carries a disk for the wall surface to be processed, this disk extending radially ouward from the axis of rotation. In an exemplary embodiment of this type, practically the entire interior space is covered by the processing tool. It is a good idea here for the disk to be built up out of two sections, where the one section of the disk has openings for the pin-like perforating tools, and the second section of the disk holds the ends of the pins in the disk and prevents them from falling out. As a result, it is again possible to achieve uniform processing. In addition, the possibility is created of using different processing tools.

To make it even simpler and easier to operate the perforating device, it is recommended that a push handle be mounted on the outside surface of the protective part, so that the device can be manipulated with two hands while in operation. One hand grips the push handle, and the other hand grips the other handle or the drive motor.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1a is a side view of the inventive device, driven here by a flexible shaft;

FIG. 1b shows another embodiment with direct drive;

FIG. 2 is a cross section through the device with a circular knife as the perforating tool;

FIG. 3 shows the device with two disk sections;

FIG. 4 is a cross section through the device, in which rollers with needle-like spikes are provided as perforating tools;

FIG. 5 shows a first embodiment of the rotating ring;

FIG. 6 shows a second exemplary embodiment of the rotating ring of the carrier; and

FIG. 7 shows a top view of the clamping ring.

### DETAILED DESCRIPTION OF THE INVENTION

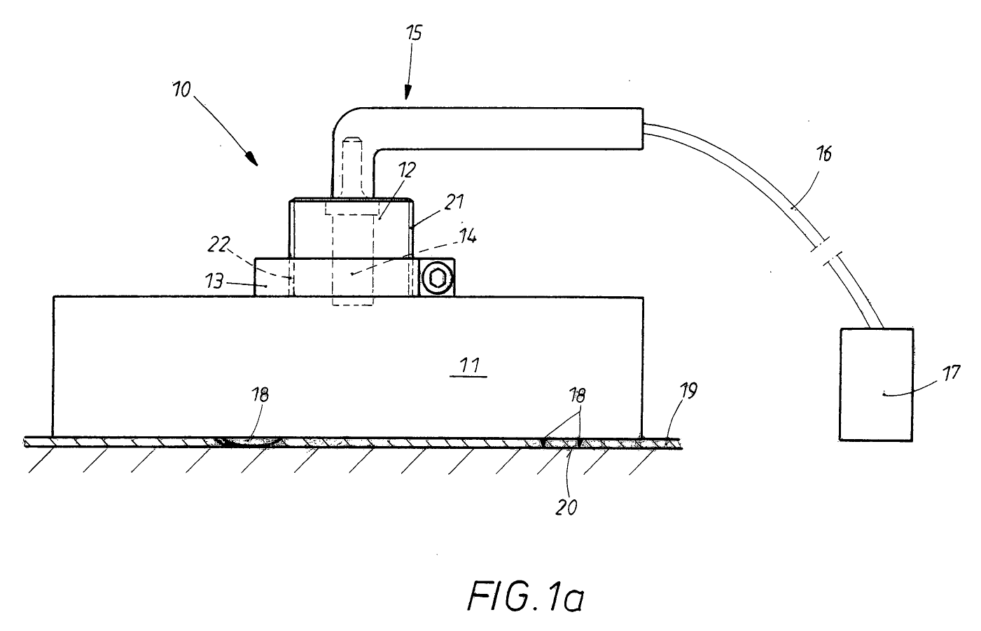

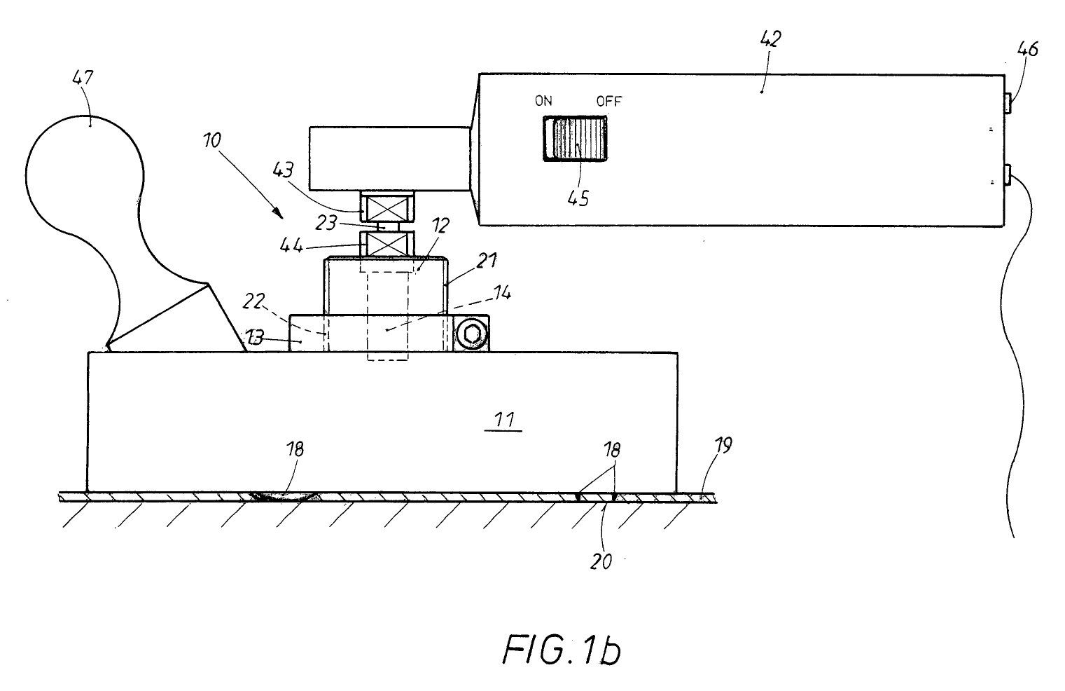

The perforating device 10 shown in FIG. 1a consists essentially of a protective part 11, from which an adjusting sleeve 12 projects. The sleeve carries a thread 21, which engages in the internal thread 22 of a clamping ring 13. The clamping ring 13 itself is held in place on the protective part 11 by a screwed joint. The end 23 of a rotating pintle 14 projects from the adjusting sleeve. A flexible shaft 16 is connected to the rotating pintle 23. The flexible shaft 16 passes through the handle 15.

The flexible shaft 16 leads to an electric drive motor 17, which can be connected to a battery or to line current. Here the flexible shaft is long enough, so that the operator can either hang the drive motor on his shoulder or carry it in a pocket.

Perforating tools 18 in the shape of circular blades project from the lower part of the hood-like protective part 11. These blades have spikes, which penetrate into the wallpaper 19 to be perforated, which is glued to a substrate. It should also be mentioned here, however, that the clamping ring could also hold the adjusting sleeve 12 nonpositively with respect to the rotational movement by means of a screw (not shown). The perforating device according to FIG. 1b has a design similar to that of FIG. 1a. The device is driven here by a motor 42, which is connected to line current and can be attached to a part 23 of the rotating pintle 14. The motor is provided with a chuck 43, which holds the part 14. By the use of a locknut 44, the attachment of the solution can be accomplished. The motor is provided with an on-off switch 45 and a speed controller 47. So that the device can be easily handled during operation, the protective part 11 has a push handle 47. During operation, therefore, the device is manipulated with two hands.

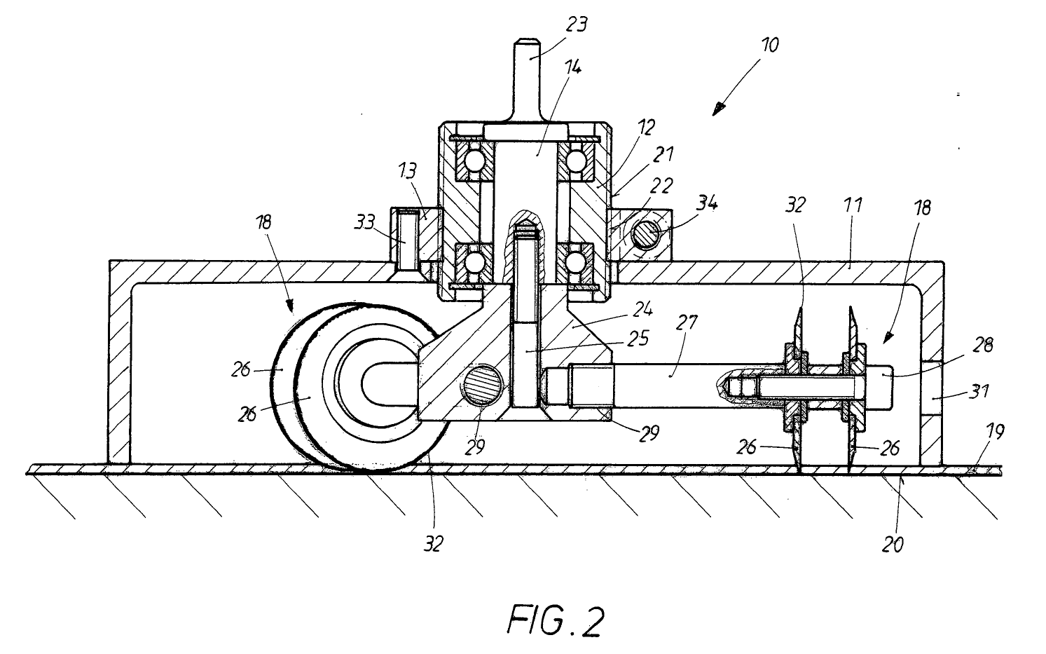

In the embodiment according to FIG. 2, the device 10 is shown without a handle.

The pintle 14 is connected nonrotatably to a rotating ring 24 by means of a fastening screw 25. The pintle and the ring form the carrier for the perforating tool 18. The pintle 14 is mounted by means of a ball bearing arrangement in the adjusting sleeve 12. The ball bearing is held in place in the adjusting sleeve 12 by means of Seeger circlip rings (not shown).

The clamping ring 13, in which the adjusting sleeve 12 is rotatably supported, is attached by means of a screwed joint 33 to the protective part 11. It should be mentioned here that the screwed joint 33 comprises several points where the ring is screwed to the protective part 11. The clamping ring is held by a clamping ring screw 34 on the outer circumference of the adjusting sleeve.

The rotating ring 24 carries threaded openings 29, which are uniformly distributed around its circumference, i.e., around its fastening screw 25. Each of these threaded openings 29 accepts an axle 27, which for its own part is provided with an outside thread at one end and which carries the perforating tool at the other end. This tool is fastened by a retaining screw 28 to the axle 27. The perforating tool is designed as a set of two circular blades 26. These circular blades are able to rotate freely. When the rotating ring rotates, the blade circumferences roll over the wallpaper 19 to be perforated. The circumference 32 of the circular blade is toothed, and it is these teeth or tooth-like spikes which penetrate into the wallpaper 19.

The protective part 11 is designed in the form of a hood. It is provided with an ejection opening 30 and with an access opening 31. The ejection opening allows pieces of wallpaper which have been torn off during the perforating operation to be ejected through the opening to prevent the perforating tool from becoming jammed. An ejection opening 30 of this type is required when the perforating tool 18 carries perforating spikes 35.

The access openings allow access to the retaining screw 28 for replacement of the circular blades. As a result, the entire perforating device does not have to be disassembled simply to replace the blades.

As can be seen in FIG. 2, the toothed circumference 32 perforates the wallpaper 19. In practice, the circumference will penetrate through the entire thickness of the wallpaper.

If the wallpaper is thicker because of layers of paint on it, the protective part 11 will have to be moved slightly away from the wallpaper 19. For this purpose, the clamping ring screw 34 of the clamping ring is loosened, and the adjusting sleeve 12 is rotated in the clockwise direction, so that the adjusting sleeve projects a bit more into the hood-like protective part 11. As a result of this height adjustment, the distance between the protective part and the circular blade acting on the wallpaper is increased, and the toothed circumference 32 can penetrate more deeply into the wallpaper when the protective part is set down. Conversely, if the wallpaper is thin or if the wallpaper is merely to be pricked, the adjusting sleeve is turned counterclockwise, and the rotating ring 24 with the perforating blade is pulled into the hood-like protective part 11.

After the adjustment has been completed, the clamping ring screw 34 is tightened again.

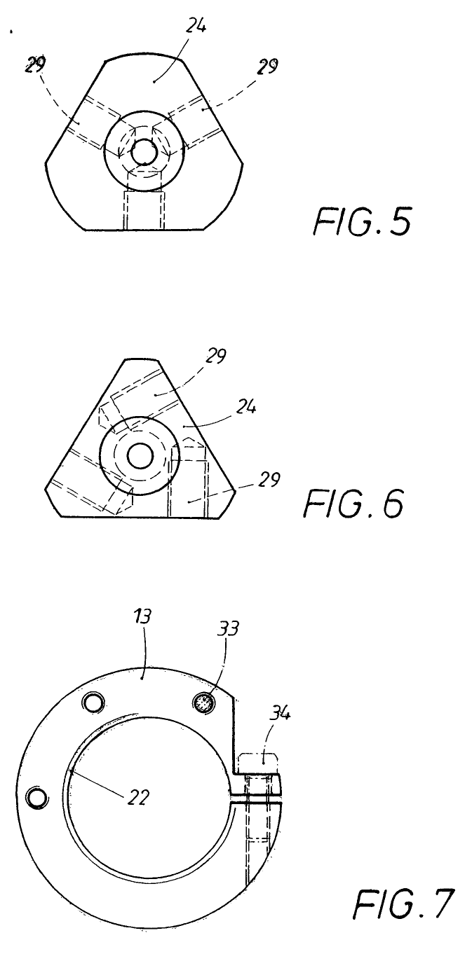

It remains to be said that, in FIG. 5, the threaded openings 29 in the rotating ring 24 are shown in broken line. When viewed from above, these are seen to be distributed uniformly around the axis of rotation of the rotating ring.

The clamping ring 13 and its clamping ring screw 34 are shown in FIG. 7. The screwed joint 33 extends over only a small angle of the clamping ring, so that, upon actuation of the clamping ring screw, the diameter of the clamping ring itself can be increased or decreased.

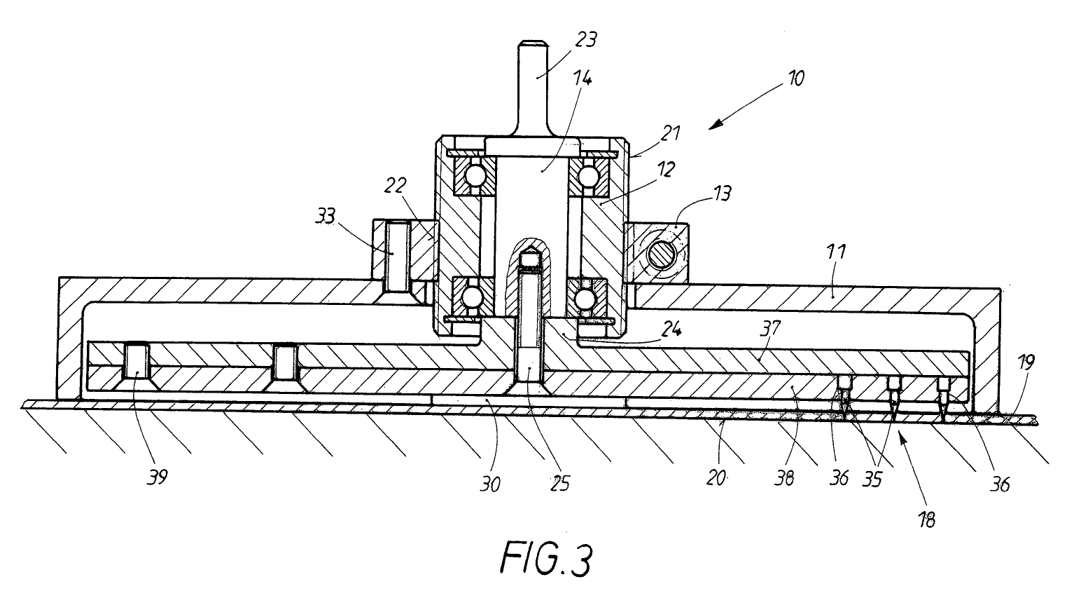

The perforating device 10 in the embodiment according to FIG. 3 has a similar design. The perforating tool 18 and the rotating ring 24, however, are different.

The perforating tool 18 consists here of two sections 37, 38 of a disk. One section of the rotating ring 24 is formed directly on one of these disk sections, namely, on section 37. The disk section 38 carries retaining openings 36. Perforating spikes 35 are inserted into these retaining openings, which are stepped in the axial direction. The two sections 37, 38 are then attached to each other by screws 39, so that the perforating spikes 35 cannot fall out of the retaining openings 36.

The two disk sections 37, 38 are then mounted on the rotating pintle 14 by means of the fastening screw 25. When the pintle rotates, the entire disk 37, 38 rotates, too, and thus perforates the wallpaper.

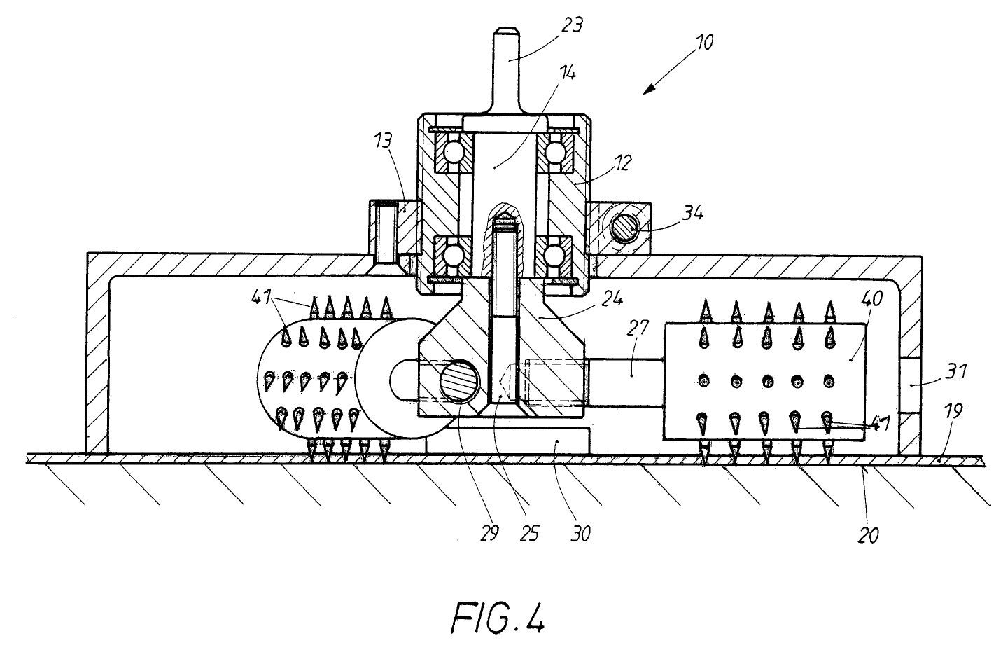

In the embodiment according to FIG. 4, the perforating device 10 has a design similar to that shown in FIG. 2. To this extent, reference is made to the previous description. The difference here is that the perforating tool 18 is provided with rollers 40, which carry several rows of spikes 41. The spikes 41 are arranged in rows extending in the axial direction of the roller 40, where the rows are spaced uniformly around the circumference of the roller 40. In addition, the threaded holes 29 for the axles 27 are arranged tangentially to the fastening screw 25 (see FIG. 6).

When the rotating ring 24 turns, the rollers with their spikes 41 roll over the wallpaper 19. The rollers 40 are mounted rotatably on the axles 27. As a result of the tangential arrangement of the threaded holes, perforations are created and at the same time these perforations are slightly displaced, with the result that the wallpaper 19 is slightly cut.

As can be seen in FIG. 5, the threaded holes 29 are aligned with the axis of rotation. The axis of rotation is determined by the opening for the fastening screw 25, where, as previously mentioned, the rotating pintle and the rotating ring rotate in common.

In the embodiment according to FIG. 6, the threaded holes are tangential to the opening for the fastening screw. When the ring rotates, the rollers 40 and their spikes 41 therefore slide slightly along the wallpaper to be processed.

FIG. 7 shows the clamping ring 13 with the clamping ring screw 33 as described in conjunction with the three embodiments.

As previously mentioned, the embodiments presented here are only examples of ways in which the invention can be realized. The invention is not limited to them; on the contrary, many different modifications and applications are possible. For example, to simplify the movement of the adjusting sleeve, the adjusting sleeve could be equipped with a turning grip. The shear-like perforating tools could also be modified in that the one part could carry a grinding section to grind away unevennesses on the substrate or to remove residual pieces of wallpaper. Finally, it should also be stated that the drive motor could also be mounted directly on the projecting part of the pintle. The motor would then merely have to be connected to a power source such as a battery, etc. The handle could then act again as an extension of the pintle or be mounted on the electric motor. It should also be mentioned that the edge of the hood of the protective part could be rounded over, so that the perforating device can slide over the wallpaper more easily. In a simple embodiment, the protective part consists of individual rods, which are arranged around the carrier which holds the perforating tool.

While specific embodiments of the invention have been shown and described in detail to illustrate the inventive principles, it will be understood that the invention may be embodied otherwise without departing from such principles.

1. A device for processing wallpaper glued to a surface, the device comprising a carrier, which is drivable in rotation by a motor and on which processing tools are provided, and a holder for the rotating carrier, wherein free ends of the processing tools act on areas of the wallpaper to be processed, and a protective part surrounding the processing tools and the carrier, wherein the processing tool is a perforating tool;
wherein, after the perforating tool has been placed on the wallpaper, a distance between the protective part and the wallpaper to be perforated is adjustable; wherein the holder of the carrier is comprised of an adjusting sleeve with a clamping ring and is attached to the protective part, and wherein the clamping ring attached to the protective part surrounds the adjusting sleeve.

2. The device according to claim 1, wherein the clamping ring has an inside thread and the adjusting sleeve has an outside thread, and wherein the adjusting sleeve is supported in the clamping ring with freedom to rotate.

3. The device according to claim 1, wherein a screw connection for holding the clamping ring on the protective part extends over only a small angle of the clamping ring, so that, on actuation of a clamping ring screw, the diameter of the clamping ring can be increased or decreased.

4. The device according to claim 1, wherein the protective part is a hood which covers the carrier, the perforating tools, and the section of wallpaper to be processed.

5. The device according to claim 1, wherein perforating tools are mounted on and uniformly distributed around a rotating circumference of the carrier.

6. The device according to claim 5, wherein the perforating tool is a circular blade.

7. The device according to claim 6, wherein the perforating tool comprises a set of two circular blades.

8. The device according to claim 1, wherein the carrier is comprised of a rotating ring and a pintle, where the rotating ring is mounted nonrotatably on the pintle.

9. The device according to claim 1, wherein the hood-like protective part has an access opening on a circumference thereof.

10. The device according to claim 5, wherein the rotating ring has threaded holes on its circumference to hold the perforating tools.

11. The device according to claim 10, wherein the threaded holes extend radially with respect to an axis of rotation of the rotating ring.

12. The device according to claim 10, wherein the threaded holes are tangential to the axis of rotation.

13. The device according to claim 1, wherein the protective part has a push handle on an outside surface thereof.
